(19) United States
(12) Patent Application Publication
(10) Pub. No.: US 2013/0171002 A1
(43) Pub. Date: Jul. 4, 2013

(54) Hybrid Wind Turbine Tower with Integrated Yaw Bearing System

(71) Applicants: Richard A. Himmelmann, Beloit, WI (US); Stephen E. Tongue, Hampden, MA (US)

(72) Inventors: Richard A. Himmelmann, Beloit, WI (US); Stephen E. Tongue, Hampden, MA (US)

(73) Assignee: Clipper Windpower, LLC, Carpinteria, CA (US)

(21) Appl. No.: 13/339,947

(22) Filed: Dec. 29, 2011

(51) Int. Cl. F03D 11/04; E04H 12/18; F16C 35/12; F16C 19/54

(52) U.S. Cl. 416/244 R; 384/548; 52/65

(57) ABSTRACT

A wind turbine includes a vertically standing hybrid tower adapted to support a horizontally oriented rotor. The tower includes a fixed base portion and a separate rotatable upper rotor swept portion adapted to be secured to the base portion and rotatably yawed into the wind. The interface between the base and upper tower portions includes a bearing system defined by a pair of vertically spaced ring bearings adapted to encase and secure a downwardly depending spindle of the upper tower portion for rotatable support thereof within a vertically oriented cup-shaped opening in the base portion. Pluralities of contact rollers situated between inner and outer races of the ring bearings are each mounted on a single spindle and preloaded in angular orientation relative to the vertical axis of the tower.

### TECHNICAL FIELD

This disclosure relates to mechanical systems for enhancing operations of wind turbines. More particularly, the disclosure relates to a hybrid wind turbine tower that includes a dual vertical bearing system adapted to permit at least a portion of the tower structure to physically rotate for optimizing wind turbine tower performance.

### BACKGROUND

The rotor blades of a utility scale wind turbine are ideally pitched toward or “yawed” into the wind. This orientation optimizes the amount of wind energy captured by the rotor, and in turn maximizes torque produced on a main shaft of the wind turbine to drive associated electric generators, for example.

Accordingly, the traditional wind turbine tower structure incorporates a rotor, a rotor shaft and bearings, collectively referred to as a turbine, along with a nacelle to support such structure. All are generally situated atop of a fixed tower, and are designed to rotate on the fixed tower structure for the purpose of maintaining the rotor in a position to always directly face the wind.

The typical tower has traditionally been constructed as a nonrotating vertically upstanding structure having a circular cross-section and generally adapted to accommodate wind forces in any given azimuthal direction. As such, traditional tower construction has tended to be relatively robust, requiring more materials than towers that could otherwise employ, for example, aerodynamic configurations that might include an airfoil and other asymmetric cross-sections adapted to rotate or yaw with the rotors and nacelle to face the wind. Such structures might require less robust configurations, utilizing reduced cross-sections to save construction material costs. Construction of such towers might require less strength/thickness in those circumferential tower portions or areas normal to the wind and/or otherwise not subject to direct wind forces.

A major limitation with respect to use of aerodynamic tower structures may have historically been related to difficulties of designing bearings adapted to accommodate the relatively high bending moments typically present near the bottoms or bases of tower structures.

### SUMMARY OF THE DISCLOSURE

This disclosure proposes a wind turbine tower that incorporates a dual bearing system below the rotor swept portion of the tower, rather than providing the traditional single yaw bearing situated atop of the tower.

In one aspect of the disclosure, the dual bearing system accommodates rotation of an upper portion of the tower, along with the turbine and the nacelle.

Another aspect of the disclosure is the provision of a hybrid tower structure, with an upper rotatable tower portion thereof having a relatively smaller cross-section in a direction normal to wind forces than that of a traditional tower.

In yet another aspect of the disclosure, a dual yaw bearing system incorporates a pair of axially spaced ring bearings having preloaded angular contact rollers.

In yet a further aspect of the disclosure, a dual yaw bearing system permits an asymmetric upper rotatable portion of the tower to yaw in response to wind forces, while providing a lower circular cross-sectioned tower portion that remains fixed to a base or a ground-secured foundation.

In a still further aspect of the disclosure, an upper portion of the tower at least coincident with the rotor swept area may be rotatably yawed into the wind, with the base portion of the tower remaining fixed.

### BRIEF DESCRIPTION OF THE DRAWINGS

FIG. 1 is an elevational frontal view of a wind turbine that embodies elements of the disclosure, depicting a rotatable upper tower portion secured via the disclosed dual ring bearing system to a fixed lower base portion of the tower.

FIG. 2 is a side elevational side view of the same wind turbine, depicting the wind facing rotor and a side of the tower parallel to the wind.

FIG. 3 is an elevational cross-sectional view of a portion the same wind turbine, depicting a dual bearing and spindle arrangement as situated at an interface of the rotatable upper tower portion and the lower fixed base tower portion.

### DETAILED DESCRIPTION

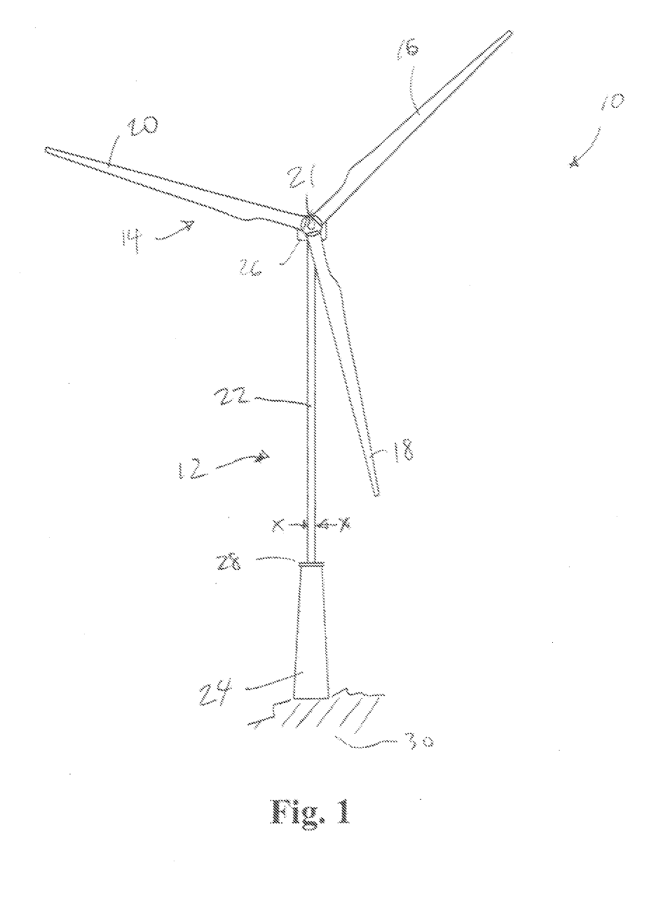

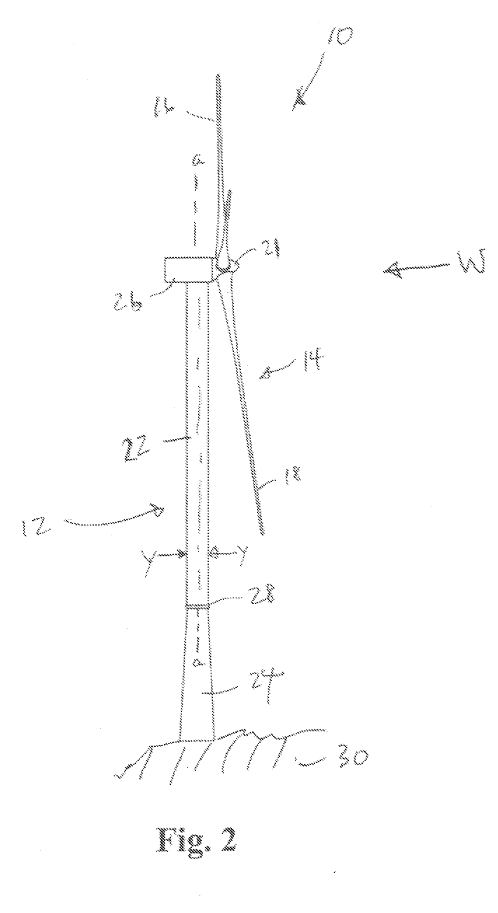

Referring initially to FIG. 1, a wind turbine 10 is shown constructed in accordance with at least one embodiment of the present disclosure. While all components of the wind turbine are not necessarily shown nor described herein, the wind turbine 10 may include a vertically standing tower 12 having an axis “a-a” (FIG. 2), and supporting a rotor 14. The rotor may be defined by a collective plurality of circumferentially arrayed, equally spaced, rotatable blades 16, 18, and 20, each connected to and radially extending from a hub 21.

The blades 16, 18, 20 (only three of which are depicted in this example; there may be more or less) may be rotated by wind energy, such that the rotor 14 may transfer that energy via a main shaft (not shown) to one or more generators (not shown). Those skilled in the art will appreciate that such wind-power driven generators may produce commercial electric power for transmission to an electric grid (not shown). Those skilled in the art will also appreciate that a plurality of such wind turbines may be effectively employed on a so-called wind turbine farm to generate significant amounts of electric power. Although the disclosed embodiment focuses on wind only, this disclosure is pertinent to fluids generally, including other gases and even liquids such as water, which may be used to drive similar turbine structures.

The tower 12 of this disclosure may be described as a hybrid tower in that it includes two distinct portions: an upper tower portion 22 that may be rotatably yawed into the wind and a lower stationary base portion 24 adapted to be secured to the ground 30. The base portion 24 is adapted to support the upper rotatable tower portion 22 at an interface 28 situated below the rotor swept area. The rotor swept area of the tower 12 is herein defined as that tower area most adjacent to, and spaced immediately behind, the spinning rotor 14.

Referring now also to FIG. 2, a side view of the wind turbine 10 shows the tower 12 as positioned into the wind, where the wind direction, indicated by arrow W, is directly into the rotor 14. In the disclosed embodiment, the upper tower portion 22 has an aerodynamic or otherwise asymmetric shape, with a minor axis XX (FIG. 1) situated orthogonally to wind direction, arrow W, and a major axis YY (FIG. 2) situated parallel with the wind. Thus, it will be seen from FIGS. 1 and 2 that the major axis YY of the upper tower portion 22 has a greater dimension than its orthogonal-to-the-wind minor axis XX. As earlier noted, the asymmetric and/or aerodynamic shape may require the use of less tower construction material, and thus may result in reduced costs.

The upper tower portion 22 may be of either a hollow or a solid cross-sectioned structure. A hollow structure may be easier to fabricate, while a solid structure may present an opportunity for use of an even smaller cross-section. Either approach may, in any event, be considered to be within the scope of this disclosure.

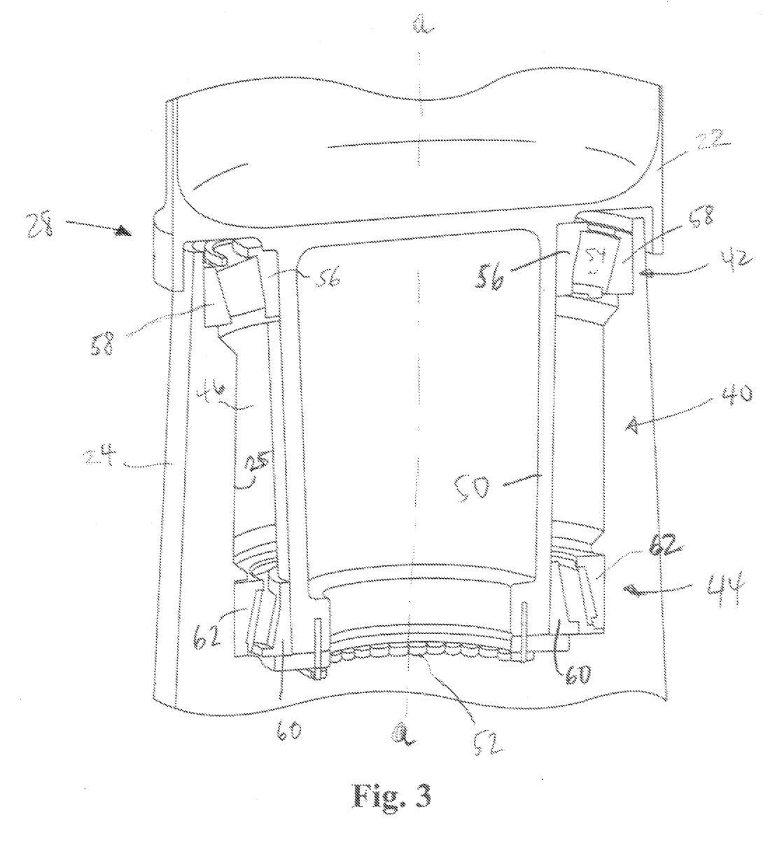

In FIG. 3, a detailed cross-sectional view of the interface 28, first referenced in FIGS. 1 and 2, depicts structural features and details of an axially spaced dual bearing system 40 that may be situated between the rotatable upper tower portion 22 and the stationary tower base portion 24.

Upper and lower ring bearings 42, 44 are vertically spaced apart along the tower axis “a-a” to secure a spindle 50 of the rotatable upper tower portion 22. It will be appreciated by those skilled in the art that the spindle portion 50 extends downwardly from, and is integral to, the bottom of the upper tower portion 22. The spindle 50 is rotatably secured within the circular interior of the respective inner races 56 and 60 of upper and lower ring bearings 42 and 44, and for this purpose the upper and lower inner races 56 and 60 are adapted to rotate with the spindle 50.

Those skilled in the art may appreciate that the spindle could, with some design modifications, alternatively extend upwardly from the lower base tower portion 22. Also, as may have been earlier implied with respect to the upper tower portion 22, the spindle 50 may alternatively be either a hollow or a solid member, which may or may not depend on whether the actual tower portion 22 is hollow or solid.

The ring bearings 42 and 44 include outer races 58 and 62, respectively, which are fixedly secured within a vertically oriented cup shaped portion 25 of the fixed tower base portion 24. Between the inner and outer races of both upper and lower bearings are situated a plurality of circumferentially spaced contact rollers 54, each mounted on a single spindle (not shown), each preloaded in an angular orientation with respect to the tower axis a-a for optimizing stability.

As depicted, the angular orientation of the contact rollers 54 in the upper bearing ring 42 is inverse to the angular orientation of the rollers 54 in the lower bearing ring 44. The inverse angular orientation of the respective sets of rollers 54 presents a design believed to offer a robust, laterally stable bearing system that may be adapted to accommodate significant asymmetrical wind forces against the yawing upper tower portion 22. Those skilled in the art may appreciate that the respective angular orientations of the sets of rollers 54 may alternatively be reversed; i.e. with the roller orientation as displayed in bearing ring 42 being utilized in place of that of the ring 44, and vice versa.

An optional annular bearing spacer (not shown) may be placed within the annular space 46 between the upper and lower ring bearings 42, 44 to reinforce the anchoring and securement of the bearing rings within the tower base portion 24. In addition, optional vertical load support bearings 52 may also be employed at the bottom of the fixed tower base portion to offer an enhanced axial support for the spindle.

Finally, although only the application of roller bearings has been described in reference to the disclosed structure, other bearing types and configurations may fall within the spirit and scope of this disclosure.

### INDUSTRIAL APPLICABILITY

The present disclosure generally sets forth a mechanical system that may enhance the utility of wind towers by making them more cost efficient. A reduction in capital costs, due to reduction in raw material usage as required to fabricate upper sections of a wind turbine tower, may be achieved by designing the rotor swept portion of the tower to be rotatable, and to incorporate an aerodynamic or otherwise asymmetric tower cross-section that requires less materials than would a standard traditional circular cross-section.

The disclosure offers a wind turbine tower that incorporates a dual ring bearing and spindle shaft arrangement positioned below the rotor swept portion of the tower, rather than incorporating a single unitary tower structure having a single yawed bearing at the top of the tower. Replacement of the traditional single yaw bearing in this manner, and supporting rotation of the upper portion of the tower structure, permits both the wind turbine and the nacelle structures to rotate with the upper tower portion. As such, wind alignment of the tower with nacelle and turbine structures can be assured, permitting the tower to be constructed with smaller cross-sections in directions normal to the wind forces.

We claim:

1. A wind turbine comprising:
a tower having a vertical axis, and a horizontally oriented rotor supported atop of the tower;
the tower including a lower stationary base portion adapted to be fixed relative to the ground;
the tower including a rotatable upper portion adapted to support the rotor at its top end, the rotatable upper portion defining a rotor swept portion and having a downwardly depending spindle at its bottom end;
the tower further including an interface between the upper rotatable and lower fixed tower portions, the interface defined by a pair of vertically spaced ring bearings having inner and outer races aligned with the tower axis, such that the upper rotatable tower portion may be supported on the lower stationary tower portion for being yawed into the wind;
wherein the lower tower base portion includes a vertically oriented opening adapted to receive the outer race of the bearings, and wherein the inner race of the bearings comprises a smaller vertically oriented opening adapted to receive the spindle for rotatable support therein.

2. The wind turbine of claim 1, wherein the lower tower base portion is positioned so as to vertically extend upwardly only to a height below the rotor swept portion of the tower.

3. The wind turbine of claim 1, wherein each ring bearing comprises a plurality of circumferentially spaced contact rollers, each roller being positioned in an angular orientation relative to the vertical axis of the tower.

4. The wind turbine of claim 3, further comprising each contact roller being preloaded and situated on individual spindles.

5. The wind turbine of claim 1, wherein the upper rotatable tower portion comprises an asymmetric cross-section having major and minor axes, and wherein the minor axis is adapted to be orthogonally positioned relative to wind direction.

6. The wind turbine of claim 5, wherein the minor axis is shorter than the major axis, and wherein the width of the upper tower portion comprises a thinner dimension thereof in a direction orthogonal to the wind.

7. The wind turbine of claim 1, wherein the upper rotatable tower portion is situated substantially within the rotor swept portion of the tower.

8. A hybrid tower for a wind turbine, the tower having a vertical axis and supporting a horizontally oriented rotor, the hybrid tower comprising:
a lower tower base portion adapted to be fixed in a stationary position;
an upper rotatable tower portion adapted to support the rotor at its top end, and further defining a rotor swept portion;
a spindle extending downwardly from the upper rotatable portion and adapted for interconnection with, and rotation within, the base portion;
a tower portion interface providing an interconnection between the upper rotatable and the lower base tower portions;
the interface including a pair of vertically spaced ring bearings having circumferentially oriented inner and outer races aligned with the vertical tower axis such that the upper rotatable tower portion may be yawed into the wind;
wherein the lower tower base portion includes an opening adapted to receive the outer races of the ring bearings, and wherein the inner races of the bearings include an opening adapted to receive the spindle for rotatable support therein of the spindle.

9. The hybrid tower of claim 8, wherein the lower tower base portion is positioned so as to vertically extend upwardly only to a height below the rotor swept portion of the tower.

10. The hybrid tower of claim 8, wherein each ring bearing comprises a plurality of circumferentially spaced contact rollers, each roller being positioned in an angular orientation relative to the vertical axis of the tower.

11. The hybrid tower of claim 10, further comprising each contact roller being preloaded and situated on individual spindles.

12. The hybrid tower of claim 8, wherein the upper rotatable tower portion comprises an asymmetric cross-section having major and minor axes, and wherein the minor axis is adapted to be orthogonally positioned relative to wind direction.

13. The hybrid tower of claim 12, wherein the minor axis is shorter than the major axis, and wherein the width of the upper tower portion comprises a thinner dimension thereof in a direction orthogonal to the wind.

14. A hybrid tower of claim 8, wherein the upper rotatable tower portion is situated substantially within the rotor swept portion of the tower.

15. A bearing system for a hybrid wind turbine tower, the tower having a vertical axis, and including a lower stationary base portion adapted to be fixed relative to the ground, and an upper rotatable portion defining a downwardly depending spindle at its bottom end adapted for rotatable interconnection with the base portion; said bearing system comprising:
an interface providing an interconnection between the upper rotatable and the lower base tower portions;
the interface including a pair of vertically spaced ring bearings having circumferentially oriented inner and outer races aligned with the vertical tower axis such that the upper rotatable tower portion may be yawed into the wind;
wherein the lower tower base portion includes an opening adapted to receive the outer races of the ring bearings, and wherein the inner races of the bearings include an opening adapted to receive the spindle for rotatable support therein of the spindle.

16. The bearing system of claim 15, wherein each ring bearing comprises a plurality of circumferentially spaced contact rollers, each roller being positioned in an angular orientation relative to the vertical axis of the tower.

17. The bearing system of claim 16, further comprising each contact roller being preloaded and situated on individual spindles.

18. The bearing system of claim 15, wherein the upper rotatable tower portion comprises an asymmetric cross-section having major and minor axes, and wherein the minor axis is adapted to be orthogonally positioned relative to wind direction.

19. The bearing system of claim 18, wherein the minor axis is shorter than the major axis, and wherein the width of the upper tower portion comprises a thinner dimension thereof in a direction orthogonal to the wind.

20. The bearing system of claim 15, further comprising vertical load support bearings positioned at the bottom of the spindle for enhanced axial support of the rotatable spindle within the fixed base tower portion.
